(19) United States
(12) Patent Application Publication
(10) Pub. No.: US 2003/0023455 A1
(43) Pub. Date: Jan. 30, 2003

(54) Method and system for reversing induced discrimination

(76) Inventor: Anne Marie Knott, Bala Cynwyd, PA (US)

Correspondence Address: Evelyn H. McConathy, Esquire, Dilworth Paxson LLP, 3200 Mellon Bank Center, 1735 Market Street, Philadelphia, PA, 19103, US

(21) Appl. No.: 10/194,782

(22) Filed: Jul. 12, 2002

Related U.S. Application Data
(60) Provisional application No. 60/305,068, filed on Jul. 13, 2001.

(51) Int. Cl. G06F 17/60

(52) U.S. Cl. 705/1

(57) ABSTRACT

Provided is a method for reversing induced discrimination in the workplace and for restoring race/gender-blind hiring wherein, using a self-selection mechanism, prospective employees reveal whether they are litigious or non-litigious. The mechanism, based upon an anti-discrimination bond, has two features that jointly reduce employer litigation costs, and thus the need to discriminate (1) an adverse selection feature that identifies litigious employees ex-ante, and (2) a moral hazard feature that inhibits litigation ex-post. The penalties for employer misconduct are, however, unaffected.

### RELATED APPLICATION

This application claims the benefit of U.S. Provisional Application No. 60/305,068, filed Jul. 13, 2001, which filing date is claimed herein, and the content of which is herein incorporated by reference.

### FIELD OF THE INVENTION

This invention relates generally to the field of employment practices, specifically a method and system by which induced discrimination is reversed and race/gender-blind hiring is enhanced.

### BACKGROUND OF THE INVENTION

Employment discrimination is generally defined by a set of five laws administered by the Equal Employment Opportunity Commission (EEOC). These include the Equal Pay Act of 1963, prohibiting sex based wage discrimination; Title VII of the Civil Rights Act of 1964, prohibiting employment discrimination based on race; color, religion, sex and national origin, the Age Discrimination in Employment Act of 1967 (ADEA), prohibiting employment discrimination against persons 40 years of age or older, the Americans with Disabilities Act of 1990 (ADA), prohibiting employment discrimination against qualified individuals with disabilities, and the Civil Rights Act of 1991, modifying the prior laws to allow compensatory and punitive damages in cases of employer “malice or reckless indifference to the rights of aggrieved individuals.”

Past empirical work has tended to show that the Civil Rights laws and EEOC enforcement have improved economic conditions for protected groups (see, e.g., Heckman et al., Amer. Econ. Rev. 79:138-177 (1989); Leonard, Amer. Econ. Rev., 86(2):285-289 (1996)). However, recent authors have expressed concerns that, to the contrary, the laws have actually induced discrimination (Posner, Univ. Pennsylvania Law Rev., 136:13-519 (1987); Donohue et al., Stanford Law Review 43:983-1033 (1991); Abram, American Economic Rev. 83(2):62-66 (1993); Acemoglu et al., NBER Working Paper 6670 (1998); Oyer et al., Working Paper 99-26, Inst. for Policy Research, Northwestern University (1991); Oyer et al., RAND J. Econ. 31:345-358 (2000)). Acemoglu et al. (1998) reported that the Americans with Disabilities Act (ADA) has actually induced discrimination of the disabled because employers must incur the physical costs of accommodating the disabled, thereby making a disabled employee more expensive than his/her non-disabled counterpart. Similarly, Oyer et al. (1999), in a study of certain legally protected categories of individuals, found that employers select away from blacks and women in an effort to avoid adverse employment litigation.

Two factors have facilitated induced discrimination of protected group employees. The first of these is the higher cost of terminating employees brought about by CRA-91. The provision allowing compensatory and punitive damages has had a primary effect on the implicit wage of protected groups because of the increased cost of a suit. Additionally, higher allowed damages have produced a secondary effect, whereby additional EEOC charges have been stimulated. This secondary effect is depicted in FIG. 1, which traces the number of charges over time, and FIG. 2, which traces the employer hazard rate (total number of charges per year as a percentage of total employment). Thus, the combination of increased cost per charge (higher damage awards), together with the increased likelihood of such charges, has substantially increased the cost of terminating an employee who falls within a legally protected group. In fact a new line of insurance, Employment Practices Liability Insurance, emerged in 1990 in anticipation of increased employer exposure from CRA-91.

Since the implicit wage for a employee is money wages plus employment litigation costs, litigious employees are more costly than non-litigious employees. Thus, all things being equal, an employer would rationally prefer hiring a non-litigious employee, thereby avoiding litigation costs, just as employers prefer to hire non-disabled employees to avoid accommodation costs.

There is no illegal discrimination in avoiding litigious employees. The problem of induced discrimination arises because there is no reliable signal of litigiousness, and thus employers use protected group membership as a proxy index for the probability of litigation by an employee. The underlying logic for use of the index is that protected group employees have more grounds on which to sue employers. The net result is that litigious employees impose an externality on protected group employees in the form of induced discrimination. This externality is dissipative—low risk employees incur losses from reduced employment opportunity (on average one week employment per protected group employee since CRA-91 [number derived from CPS data for the years following CRA-91]), while the offsetting gains to high-risk employees are trivial (the expected value of a plaintiff award in employment cases is less than $1000, wherein the number is derived from all federal employment suits terminated in 1996. The data comes from the Integrated Data Base (IDB)).

Thus, is appears that induced discrimination can be avoided if money wages for protected groups are allowed to adjust to correct for the higher termination costs. However, wage discrimination is unlawful under EEOC regulation. An alternative adjustment mechanism would be to increase the hiring costs of young white males. This is accommodated through anti-discriminatory hiring provisions in the EEOC regulations. Hiring non-protected employees would, however, lead to legal costs from lawsuits by rejected candidates from protected groups. Nevertheless, the incidence of EEOC hiring charges is much lower than that for termination charges (FIG. 3). The lower incidence of hiring charges may be due to greater difficulty in demonstrating hiring discrimination (since the applicant is unlikely to know anything about competing applicants), or to the fact that economic damages from hiring discrimination are likely lower, since the applicant has no specific investment in the prospective employer. Thus, while greater hiring costs of young white males may in principle offset the higher termination costs of protected groups, such that nominal wages are equal for comparable human capital, this does not appear to be happening in practice.

Clearly, then a need remains for a reliable method by which race/gender-blind hiring is restored that will reduce total litigation, and therefore employer incentives to discriminate, without reducing penalties for employer misconduct.

### SUMMARY OF THE INVENTION

The present invention comprises a method, using a self-selection mechanism through which prospective employees reveal whether they are litigious, to reverse induced discrimination in the workplace and to restore race/gender-blind hiring. The mechanism has at least two features that jointly reduce employer litigation costs, and thus the need to discriminate—an adverse selection feature that identifies litigious employees ex-ante, and a moral hazard feature that inhibits litigation ex-post. The penalties for employer misconduct are, however, unaffected.

The higher penalties for discrimination under the Civil Rights Act of 1991, in conjunction with low “detection probabilities” for hiring discrimination appear to have induced hiring discrimination. Employers use protected group membership as a proxy for identifying high-litigation-risk employees in the absence of reliable indicators of true litigation risk. Thus, litigious employees (the real risk group) have imposed an externality on protected group employees by raising the perceived cost of hiring from protected groups.

The present invention, thus provides as method using an anti-discrimination bond to reverse the employer's need to discriminate. The method works, first because it appears that a litigious personality trait does exist. Second, the bond effectively separates employees with the trait from those without it ex-ante. Third, because the trait is not correlated with protected group membership, use of the mechanism offers a way of restoring race/gender-blind hiring. Fourth, the moral hazard feature of the bond further deters lawsuits ex-post.

Additional objects, advantages and novel features of the invention will be set forth in part in the description, examples and figures which follow, and in part will become apparent to those skilled in the art on examination of the following, or may be learned by practice of the invention.

### DESCRIPTION OF THE DRAWINGS

The foregoing summary, as well as the following detailed description of the invention, will be better understood when read in conjunction with the appended drawings. It should be understood, however, that the invention is not limited to the precise arrangements and instrumentalities shown.

FIG. 1 graphically depicts the trend in the number of discrimination charges received by the EEOC and the Fair Employment Practices Agencies (FEPA).

FIG. 2 graphically depicts the annual hazard rate of discrimination charges (EEOC+FEPA)/total employment.

FIG. 3 graphically depicts EEOC charges by type over time (hiring versus termination).

FIG. 4 presents a histogram of litigiousness for the subject pool.

FIGS. 5A and 5B graphically depict the ability of the bond method to discriminate litigious versus non-litigious employees (defining litigiousness as a binary variable with 1 sigma threshold). In FIG. 5A the effects of increased price are shown when there is no employer matching; in FIG. 5B there is 50% employer matching.

FIG. 6 graphically depicts the effectiveness of bond as a moral hazard mechanism.

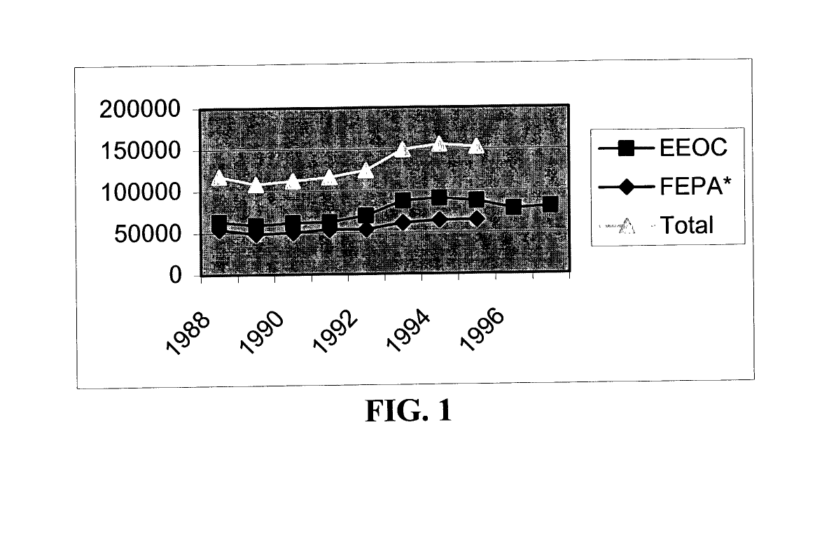

### DESCRIPTION OF PREFERRED EMBODIMENTS OF THE INVENTION

The present invention comprises a novel method and system to reverse the problem of induced discrimination, that appears to be more welfare-enhancing than merely reversing CRA-91. The goals of the invention comprise 1) restoring the relative employment opportunities of protected groups to pre-CRA-91 levels, 2) retaining penalties for employer misconduct, and 3) doing so without introducing net new costs to employers and employees.

The method comprises using and anti-discriminatory bond that is offered to all employees (protected groups as well as young white males) prior to the employment contract. The bond charges employees annual premiums that are accumulated in individual accounts and are redeemable at termination or retirement, so long as the employee has not filed suit against the employer on an employment related matter. If however, the employee has filed an employment-related suit, the accumulated principal from the premium payments are forfeited. For purposes of the mechanism theory, it does not matter where the forfeited principal goes. It does appear to matter for implementation—people feel that use of the forfeited funds to cover employer legal expenses rewards discriminatory behavior.

This bond has two features that potentially restore race/gender-blind hiring. These are (1) an adverse selection feature of identifying litigious employees ex-ante, and (2) a moral hazard feature of reducing employee incentives to litigate ex-post.

1. Adverse Selection

The adverse selection problem is solved through a self-selection mechanism similar to that proposed by Spence, Quar. J. Econ. 87(3):355-374 (1973) and Rothschild et al., Quar. J. Econ. 80:629-649 (1976). The population of employees is in general assumed to be comprised of two types of workers—litigious, l=1 and non-litigious, l=0. Litigious workers exist in proportion λ of the population; non-litigious workers exist in proportion (1−λ) of the population. The feature distinguishing litigious workers from non-litigious workers is their litigation thresholds. Thus, there are some incidents that workers of type l=1 would view as discriminatory, while the same incidents would be viewed merely as nuisances by workers of type l=0. (For a discussion of cohort effects (difference in litigation thresholds over generations) (see Donohue et al., 1991.)

For the purposes of the present invention, the “threshold difference” is viewed as a difference in the probability of a lawsuit resulting from a given employment episode. Non-litigious workers (l=0) sue for the episode with probability, ρ; litigious workers (l=1) sue for the episode with probability ρ+δ. The probability of encountering an episode is unknown, but the expected value of an award (A) is assumed to be known.

In accordance with the present method, prospective employees are offered an opportunity to invest in the anti-discriminatory bond prior to employment. Employees who purchase the bond pay annual premium, c, with cumulative contributions, C, and receive a principal, P(c), upon termination as long as they have not filed an employment suit against their employer. If an employee does file suit, he forfeits P, but begins the legal process, which has an expected value, A, of an award.

Workers thus choose whether to purchase the bond based upon their personal preferences and their prospects for litigation. The employer observes the signal provided by a prospective employee's purchase choice, and decides whether or not to employ the individual. There are two possible payoffs for each of workers' two actions:

Purchase Insurance

| Litigate | No | Yes |
|---|---|---|
| No | 0 | P-C |
| (1 − ρ) or (1 − (ρ + δ)) | | |
| Yes | A | A-C |
| ρ or (ρ +δ) | | |

The employer's objective function is to minimize total costs, by his/her choice of c and P(c):

Min [(1−λ)[(1−ρ)(P(c)−C)+ρ(A−C)]+(λ)[(ρ+δ) A]] (1)

Subject to employee incentive compatibility constraints for the respective types, non-litigious employees prefer insurance:

[(1−ρ)(P−C)]+[ρ(A−C)]≧[(1−ρ)(0)]+[ρ(A)] (2)

wherein P≧C/(1−ρ).

Litigious employees prefer to forego insurance:

[(1−(ρ+δ)) (P−C)]+[(ρ+δ) (A−C)]≧[(1−(ρ+δ)) (0)]+[(ρ+δA] (3)

wherein P≧C/(1−(ρ+δ).

These constraints are jointly satisfied for values of P with the following relationship to C:

C/(1−ρ)≦P≦C/(1−(ρ+δ)) (4)

2. Moral Hazard

An interesting byproduct of the ex-ante separating mechanism is that it also functions as a moral hazard mechanism ex-post. The worker's choice in the first round modifies incentives in the second round. If we assume that A is actually a range of awards, rather than a single value, then we can interpret p as cumulative distribution function over A. Then the role of the forfeiture amount, P, is to reduce the net award from A to (A−P), effectively shifting ρ to the left. Thus for all values of A, the probability of litigation is reduced. Moreover, the amount of reduction is increasing over time for each employee as the accumulated principal increases.

Thus, it appears that a separating price may be established, such that non-litigious employees buy the bond, while litigious employees do not. This conclusion rests on a number of assumptions. First that there are two types of employees (litigious and non-litigious), and that the probability of suit differs between the two groups by δ. Similarly ρ and δ are theoretical constructs that cannot be characterized with existing data. This is true because the constructs rely upon a personality trait that has not been characterized, on a “representative” episode, and upon knowing the hazard rate for the representative episode. The only data that currently exists is an aggregate hazard rate over all personality types and episodes. Since P and C rely upon ρ and δ, first ρ and δ must be characterized to demonstrate that a separating price exists.

To test the theory, it must either be fully implemented (which is difficult without knowing the separating price), or a controlled experiment can be conducted. For the purposes of the present invention, a test-bed approach has been adopted, similar to that of Cox et al., Rand J. Economics, 18(3):348-359 (1987) and Plott et al., J. Econ. Behavior and Organization 31:237-272 (1996). This test bed represents the second stage in a three-stage process of theory, controlled experiment, and field test.

The controlled experiment is presented as an example for purposes of illustration to those skilled in the art, and is not intended to be limiting. Moreover, this example is not to be construed as limiting the scope of the appended claims. Thus, the invention should in no way be construed as being limited to the following example, but rather, should be construed to encompass any and all variations which become evident as a result of the teaching provided herein.

### EXAMPLE

The primary goal of the experiment was to test the empirical impact of the present method of the invention. Doing so required a demonstration of the existence of three things:

a) That there are two types of employees (litigious and non-litigious);

b) That there is a price that separates the two types ex-ante (adverse selection); and

c) That there is a level of accumulated principal that inhibits litigation ex-post (moral hazard).

### Subjects

The 39 subjects in this experiment were recruited from students in the Wharton Evening Program at the Wharton School of Business at the University of Pennsylvania. The Wharton Evening Program is an outreach program for Philadelphia-area adults working full-time while pursuing a degree in the evening. Recruiting was conducted from this pool because of the saliency of employment. The subjects were all currently employed and averaged 11.4 years of full-time work experience. Thus, employment issues for these subjects were current rather than prospective or retrospective. Moreover, qualitative comments indicate that the subjects understood the employment issues and took them seriously. For example:

“I have chosen not to sue based primarily on personal views about employment. From actual experience I know I would confront my employer directly, seek a satisfactory remedy/compensation within the firm, or leave.”

The subjects had no prior experience with the experiment.

### Procedures

The experiment was conducted on-line over a five-day period. Subjects could logon and complete the experiment at any convenient time within the five-day window. While this is unusual for experiments, it was necessary in order to achieve high participation from individuals who are essentially working two-jobs. The primary concern with this approach was that subjects might communicate with one another between experiments. The value in doing so was minimized by withholding from the subjects the outcomes or the payoffs for any given experimental round. Furthermore, evidence of communication was tested by searching for a trend in responses across subjects. No such evidence was observed. Students were paid electronically after completing the experiment in a lump sum for all rounds.

Each online session consisted of 12 experimental rounds, followed by a series of demographic/psychographic questions. The collection of personal data was important for three reasons: (i) to validate and characterize the litigiousness trait, (ii) to demonstrate that litigiousness is uncorrelated with protected group, and (iii) context was introduced to examine factors affecting behavior in that context.

The entire online session lasted approximately 40 minutes. Students used an experimental currency, G (gammas) throughout the game. Gamma denominations were intended to look like typical salary denominations, but the exchange rate (to determine subjects' earnings) was G10,000 to $1.00. Students were compensated according to their choices, but on average they earned about $20.00 for the 40-minute session.

There were twelve rounds in the experiment. The first three rounds were abstract, and framed as investment decisions. The last nine rounds were contextual, and framed as employment decisions.

In each round of the experiment, subjects had to make two decisions. The first decision was the bond purchase decision (in the abstract cases, the equivalent of bond purchase was paying an ante). The bond purchase price (ante amount) varied over the games. While subjects were told that the bond/ante always appreciated (multiplied by some amount, strictly greater than one), they were not told the appreciation rate. This was done because it was important to preserve uncertainty about the principal that would be accumulated in the second stage. The same approach was used in both the abstract rounds and the contextual rounds.

The second decision was the litigation (lottery) decision. The odds of winning an award (either lawsuit or lottery) were the same for all twelve round, and subjects were told the odds:

1 in 400 chance of winning an amount less than G50,000

1 in 1000 chance of an amount between G50,000 and G200,000

1 in 2000 chance of an amount between G200,000 and G1,000,000

1 in 4000 chance of an amount larger than G1,000,000.

These award frequencies represent the award amounts of all employment cases terminated in federal court in 1996. The frequencies were derived from the integrated database (IDB) of civil cases.

If subjects did not purchase the bond (or ante) in the first stage of an experimental round, then it cost them nothing to sue (enter the lottery) in the second stage of that round. If they did purchase the bond (ante), then they forfeited the appreciated value of the bond (ante) earned there in order to sue (enter the lottery) in the second stage.

If subjects chose not to sue (enter the lottery), they kept the accumulated principal from the bond (ante).

In each of the 12 rounds, the amount subjects earned from the lawsuit (lottery) was determined by random draw from the distribution specified above. Subjects were paid electronically following the session. Their total payment was the sum of the initial endowment, plus the earnings from each round.

### Experimental Design

Four factors varied across the twelve rounds: (i) the bond premium (ante amount), (ii) employer matching (50% of the premium, or no matching) in Stage 1, (iii) accumulated principal (forfeit amount) in Stage 2, and (iv) the scenario. The ante amounts were expressed in experimental currency (Gammas). In the contextual rounds, they were also expressed in percentages of salary, where the base salary was set at G50,000. The contributed percentages corresponded to typical payroll deduction amounts for various forms of insurance: 2% (G1,000), 3% (G1,500) and 5% (G2,500).

The forfeited amounts were also expressed in experimental currency. These amounts were intended to represent salary denominations, since employee buyouts are often expressed as “weeks of salary.” The four forfeit amounts were: G0, G12,500 (25% annual salary), G25,000 (50% annual salary), and G50,000 (100% annual salary).

Three employment episodes were applied, each of which was legally actionable. All episodes were purposefully ambiguous. They involved both culpability on the part of the employee, and some on the part of the employer. However, there was no egregious behavior. The scenarios were intended to represent ones that might occur even in the case of well-meaning employers.

The first episode was constructive termination, the second was sexual harassment, and the third was discrimination. All episodes were written such that they would apply to all employees (protected or otherwise). For example the sexual harassment case does not refer to gender, and discrimination case pertains to a religious outgroup without specifying the ingroup religion—thus it was applicable to employees of any religion (or no religion).

Table 1 summarizes the structural features of the experiment. The experimental rounds were in the same order to all subjects. In addition tests were conducted to determine whether there were order effects across the rounds through a trend regression of experimental results. There was no significant trend.

TABLE 1
Experiment Design

| | | | | Forfeit |
|---|---|---|---|---|
| | | Ante/Bond Amount | Employer | Amount in |
| Round | Scenario | in Gs | Matching | Gs |
| 1 | Abstract | 1500 | | 25000 |
| 2 | Abstract | 1000 | | 12500 |
| 3 | Abstract | 2500 | | 50000 |
| 4 | Constructive | 2500 | 50% | 50000 |
| | Termination | | | |
| 5 | Constructive | 1500 | 50% | 25000 |
| | Termination | | | |
| 6 | Constructive | 1000 | | 12500 |
| | Termination | | | |
| 7 | Sexual | 1500 | 50% | 25000 |
| | Harassment | | | |
| 8 | Sexual | 1000 | | 0 |
| | Harassment | | | |
| 9 | Sexual | 2500 | | 50000 |
| | Harassment | | | |
| 10 | Discrimination | 0 | | 12500 |
| 11 | Discrimination | 0 | | 25000 |
| 12 | Discrimination | 0 | | 50000 |

### Discrimination Litigiousness

To investigate the existence of a litigious trait, two structurally equivalent experiments were created. One was abstract (lottery) and the other was framed as an opportunity to sue an employer. If there is a litigious type of individual, then such individuals should respond differently to he abstract and contextual scenarios with identical payment/payoff structures. In particular, they should be more likely to enter a lawsuit than an equivalent lottery. If there is no such trait, context shouldn't matter—each subject should respond in the same manner to the lawsuit as he/she does to the equivalent lottery.

To determine the existence of a litigious trait, all lawsuit decision observations were paired for an individual with his/her lottery equivalent, based on the amount being forfeited. This resulted in six paired observations for each subject. The forfeiture amount was the same within a pair, but varied across the pairs.

For each paired observation, a variable, “delta,” was constructed, which is the lawsuit decision (buy=1, don't buy=0) minus the lottery decision. If there is no litigious trait, then all subjects should have reached the same decision for the lawsuit that they did for the equivalent lottery, and delta would always be zero. If delta is non-zero, then litigiousness is characterized as an individual's propensity to treat the cases differently, controlling for forfeiture amounts, and specific scenario:

Deltaᵢⱼₖ=β₁+Σβ₂ⱼ(Forfeitj)+β₃ₖ(Scenario k)+β₄ᵢ(individual i) (5)

The set of coefficients, β₄ᵢ, are the primary measures of individual litigiousness. They form a continuous variable bounded at −1 and +1.

Note that this test of litigiousness controls for differences in risk aversion and money utility. The ultimate decision to sue will combine litigiousness, risk aversion and money utility. While the traits are later combined to determine the economic impact of the bond mechanism, in this example attention was restricted to the litigiousness trait.

### Discrimination Per Se

For the bond to be effective in reversing induced discrimination, then litigiousness may not be correlated with membership in any protected group. This is necessary because the intent of the bond is to discriminate on the basis of litigiousness (the true risk group), rather than on protected group membership (the proxy for the risk group). To verify that litigiousness is uncorrelated with protected group, each individual's litigiousness score was regressed based upon education, ethnicity and age.

### Adverse Selection

Once litigiousness was characterized, the adverse selection feature of the bond was tested with the question, “Does willingness to purchase the bond separate litigious employees from non-litigious employees?” In conjunction with adverse selection, the existence of a price (or range of prices) was tested at which the bond separates the two groups. To do so, bond purchase was examined in the employment scenarios as a function of bond price, level of employer matching, and individual litigiousness. In accordance with the proposed hypothesis, it was expected that a price would be found at which the likelihood of bond purchase was positive and significant for non-litigious individuals, yet near zero for litigious individuals.

### Moral Hazard

The test for the moral hazard feature of the bond, the ability to suppress suits ex-post, was very similar to the test for litigiousness. However, in this case, the absolute probability of suit was tested, rather than the likelihood of suing relative to entering an equivalent lottery. This reintroduced the risk aversion and money utility that was controlled for in characterizing litigiousness. This combined measure gives employers a sense of their overall suit hazard.

The probability of suit was examined as a function of forfeiture amount, scenario, and individual litigiousness. This allowed for the characterization of experimental values for the theoretical constructs ρ (the probability of suit for non-litigious individuals in the absence of forfeiture) and δ (the increased probability of suit for litigious individuals).

### Demonstrated Litigiousness

Based upon a constructed variable, “delta,” which was the contextual decision (buy bond=1, don't buy bond=0) minus the abstract decision (ante=1, don't ante=0) for all pairs of structurally equivalent rounds, the data indicate that there was heterogeneity for delta. The mean value for delta was −0.25. This suggested that on average, subjects are litigation averse, rather than litigious. However, to establish that finding more conclusively, equation 1 was used to estimate individual litigiousness (fixed effects), while controlling for scenario and forfeiture amount. The results from that analysis are presented in Table 2.

TABLE 2
Results for test of litigiousness
Dependent variable = Delta (Context decision-context-free decision)
Number of observations = 228

| | 1 | 2 | 3 | 4 |
|---|---|---|---|---|
| Forfeit 25,000 | 0.634 | 0.570 | | |
| | 0.092 | 0.075 | | |
| Forfeit 12,500 | 0.466 | 0.399 | | |
| | 0.113 | 0.087 | | |
| Forfeit 50,000 | 0.603 | 0.538 | | |
| | 0.092 | 0.075 | | |
| Harassment | 0.166 | | −0.118 | |
| | 0.076 | | 0.069 | |
| Discrimination | 0.151 | | 0.151 | |
| | 0.059 | | 0.066 | |
| Individual fixed effects | Included | Included | Included | Included |
| Constant | −0.671 | −0.512 | −0.134 | −0.087 |
| | 0.154 | 0.141 | 0.151 | 0.151 |
| R-squared | 0.713 | 0.700 | 0.625 | 0.591 |
| | 0.645 | 0.633 | 0.545 | 0.509 |

Omitted variables are forfeiture=0 and constructive termination scenario.

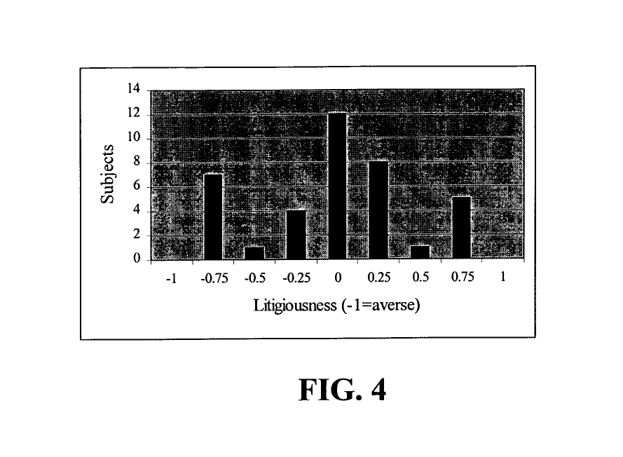

When scenario and forfeiture amount were controlled, the mean litigious coefficient was −0.14. The mean standard error on the coefficients was 0.21. The entire distribution for the litigiousness metric for the subject pool is shown in FIG. 4. Of the 39 subjects, 16% were found to be significantly litigious at the 0.95 level, while 21% were significantly litigation averse. More importantly, 53% of subjects were litigation neutral. Thus, there does appear to be a “litigiousness” trait. (In a separate paper, the inventor has made a factor-based analysis based upon a series of psychographic questions to determine the psychological indicators of litigiousness.)

Accordingly, a method for separating litigious employees from non-litigious employees solves the employer's problem of minimizing litigation risk. However, to solve the more important problem of reversing induced discrimination, it was necessary to further demonstrate that the litigiousness trait is uncorrelated with a protected group.

### Correlation of Litigiousness with Protected Group Membership

Next, litigiousness was examined to determine whether it was correlated with protected group membership. This was important because the bond's ability to restore race/gender-blind hiring relies upon the use of litigiousness, rather than protected group membership to identify high-risk employees. If litigiousness was correlated with protected group membership, then its use to screen employees could not reverse the discrimination induced by CRA-91. In addition, if bond avoidance is correlated with protected group membership, then it is per se discriminatory (and thus illegal), even if the employer's intent was not to discriminate against protected groups.

Results in Table 3 indicate that none of the collected demographic variables was significant with regard to explaining litigiousness. Thus, the value of using the bond to reverse induced discrimination remained intact.

TABLE 3
Results for test of correlation between litigiousness and protected group.
Dependent variable = litigiousness coefficient
38 observations

| | |
|---|---|
| Male | −0.119 |
| | 0.172 |
| Age: 22-27 | 0.446 |
| | 0.595 |
| Age: 28-34 | 0.119 |
| | 0.560 |
| Age: 35-44 | 0.386 |
| | 0.568 |
| Age: 45-54 | −0.104 |
| | 0.618 |
| African American | −0.190 |
| | 0.341 |
| Asian | 0.075 |
| | 0.217 |
| Hispanic | −0.188 |
| | 0.526 |
| Other | −0.824 |
| | 0.500 |
| Associates Degree | −0.279 |
| | 0.335 |
| Bachelors Degree | −0.522 |
| | 0.303 |
| Masters Degree | −0.483 |
| | 0.345 |
| Doctoral Degree | −0.067 |
| | 0.425 |
| Intercept | 0.057 |
| | 0.491 |
| R-squared | 0.400 |
| Adjusted R-squared | 0.075 |

Omitted variables are: Age <22; Ethnicity: Caucasian; Education: High school/Vocational School.

In addition to the primary aim of the demographic test, it was interesting to note the direction of the coefficients in the table. Most of the protected groups (African American, Hispanic, and over 40) have negative coefficients, reflecting litigation aversion. This may be a reaction to the externality imposed by the litigious members of the protected groups. In particular, these subjects may have first hand experience with the repercussions of litigious colleagues beyond the hiring discrimination presently examined. The exceptions are female and Asian subjects.

Similarly, the coefficients on age, while not significant, tended to reflect the cohort effect noted by Donohue et al. (1991)—younger subjects were more likely to view episodes as discriminatory. Finally, the coefficients tended to decrease with education (with the exception of Doctoral degree, which is an outlier). This is consistent with the view that education is an alternative source of power in resolving disputes. Taken together the coefficients, while not independently significant are consistent with expectations regarding employee litigation behavior. Accordingly, the test offered a degree of external validation regarding the measure of litigiousness as shown in this sample.

Accordingly, the test demonstrated that there is a litigiousness type of individual, that it appears to have external validity, and most importantly, that it is uncorrelated with protected group membership in the subject pool. Thus, if the bond is effective as an adverse selection method, it does have the potential to restore blind hiring. As a result, the next step was to examine whether the bond is, in fact, effective as an adverse selection mechanism.

However before doing so, the continuous measure of litigiousness, individual delta, β₄ᵢ, had to be converted into a discrete measure. This was necessary to match the theory developed previously, where employees were classified into one of two types: litigious versus non-litigious. To do so, a threshold for the litigiousness measure was defined. All subjects with a litigiousness score above the threshold were classified as litigious, and all subjects with a score below the threshold were considered to be non-litigious. While alternative thresholds were tested, and achieved the same qualitative results, the most reliable threshold appeared to be one standard deviation above mean litigiousness. The three classifications were carried into the adverse selection test and used by regression to predict who would buy the bond. The coefficients on control variables were comparable across the three models, but the best fit (log-likelihood) was achieved when litigiousness was defined by the 1σ threshold. Thus, the threshold for classifying litigiousness was set at +0.08 (−0.14 (μ)+0.21(σ)).

### Adverse Selection

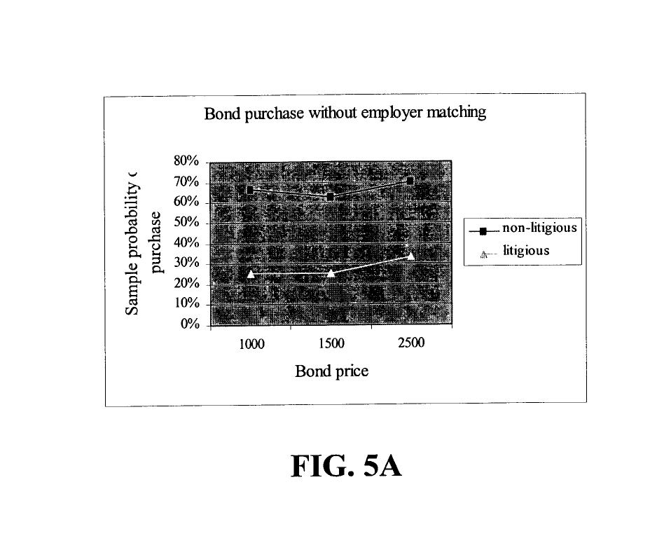

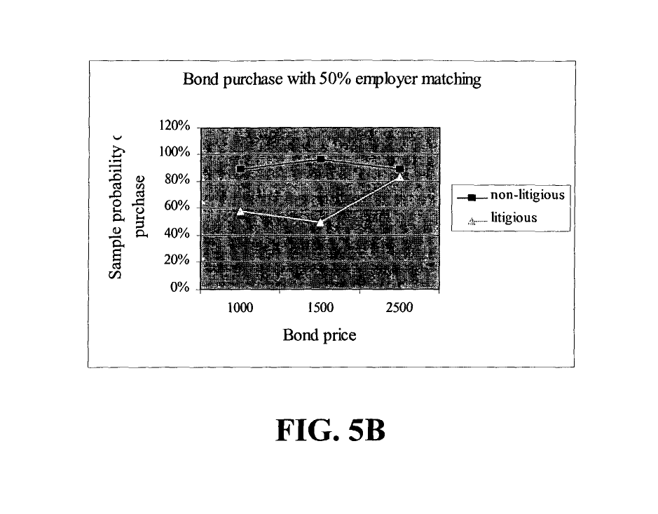

Having established individual delta as a continuous measure of litigiousness, and having segregated that trait into two classes, the next test determined whether the bond could be used to separate individuals into the two classes. FIG. 5 summarizes the propensity to buy the bond as a function of the premium price for each of the two employee types. As shown in FIG. 5A the results include no employer matching, while in FIG. 5B the results include 50% employer matching. The decomposition of results in this manner highlighted the two employer decisions regarding the bond offer: the bond premium, and whether or not to match.

FIG. 5A indicates that without employer matching, non-litigious employees were 2.1 to 2.6 times more likely to purchase the bond as compared with litigious employees. Non-litigious employees were 63% to 70% likely to purchase the bond, while litigious subjects were only 25-30% likely to purchase the bond. Willingness to purchase the unmatched bond appeared to be insensitive to the premium price.

The same comparison was drawn in FIG. 5B, except in this case, the employer matched 50% of the employee's premium for the bond. In this scenario both groups were significantly more likely to purchase the bond than they were without matching. Non-litigious employees were 89 to 96% likely to purchase the bond, as compared to 63% to 70% without matching. Again for non-litigious employees, the purchase decision appears to be insensitive to price.

Results differed for litigious employees. While they too were far more likely to purchase the matching bond than the non-matching bond (58% to 83% versus 25% to 33%), their likelihood of purchase appears to be affected by the bond premium. As the bond premium increased from 1500 to 2500, the probability of purchase increased 60% (from 50-58% to 83%). Presumably this reflects a willingness to pay more to capture the additional income. The reason that a correspondingly increased response was not seen in non-litigious employees was simply that their participation rate was already at 90%, even without matching.

Thus, there appears to be a range of prices over which the bond purchase decision effectively separates litigious employees from non-litigious employees. This was most pronounced when there was no employer matching. Accordingly, to achieve the adverse selection benefits of the bond, an employer should offer the bond without matching premiums.

Interestingly, there appeared to be a pooling equilibrium as well. It was possible to find a bond price with employer matching that attracted over 80% of subjects from both groups. Consequently, if the bond is effective as a moral hazard mechanism, then employers may want to implement a strategy of full participation, rather than using the bond as an adverse selection tool.

### Suit Propensities and Moral Hazard

The test for the moral hazard feature of the bond was similar to the test for litigiousness. However, with regard to the effectiveness of the bond as a moral hazard, the absolute probability of suit was examined, rather than the likelihood of suing relative to entering an equivalent lottery. Thus, this test reintroduced individual risk aversion and money utility (factors that were controlled in the trait definition test). Accordingly, this test was also useful for characterizing the theoretical constructs, ρ and δ.

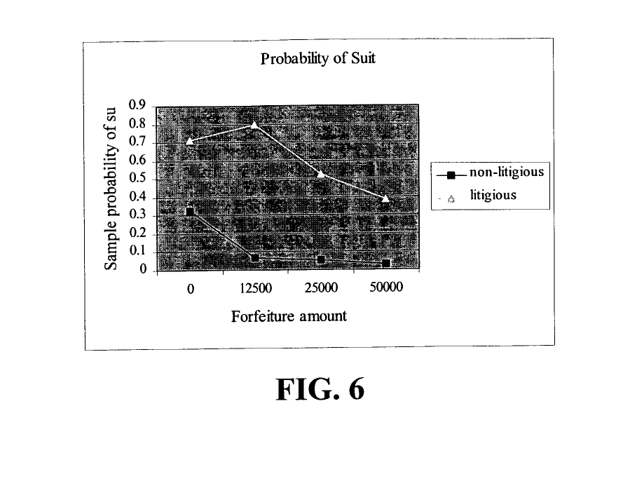

Results from both analyses are presented in FIG. 6. To establish experimental values for the theoretical constructs, ρ and δ, the probabilities of suit were examined in the absence of forfeiture amounts. When it was costless to sue (no principal is forfeited), FIG. 6 indicates that the probability of suit for non-litigious subjects was 33%. This was comparable to the suit probabilities in the absence of the bond, and thus establishes the experimental value for ρ. To establish the experimental value for δ, it was necessary to find the increase in suit probability for litigious types. As shown in FIG. 6, for litigious subjects, the probability of suit, in the absence of a forfeiture amount, was 71%. Since the probability of suit for litigious individuals was ρ+δ, the value of δ was 0.71−0.33=0.38.

Consequently, the foundational assumptions of the present theory has been verified, in that there are two types of employees (litigious and non-litigious), and that there are different suit propensities for the two groups. Moreover, the experimental values have been characterized for individual litigiousness, β₄ᵢ, as well as the two measures of suit propensity, ρ and δ. Although the experimental scenarios were contrived and deliberately benign, the experimental values for δ₄ᵢ, ρ and δ are most likely an understatement of real-world values.

The results of the moral hazard test indicate that the bond principal is effective in deterring suits among both litigious and non-litigious employees. The probability of suit fell dramatically (to 7%) for non-litigious subjects when a forfeiture amount was introduced, and declined gradually thereafter. At the highest forfeiture level, the probability of suit was 3%. In contrast, for litigious employees, forfeiture amounts below some threshold (experimentally 12,500) had little effect in dissuading those individuals from suing. However, suit probabilities decreased significantly with forfeiture amount once that threshold was exceeded. Specifically, the suit probability of 80% at a bond price of 12,500 fell to 38% at a bond price of 50,000. Thus, a strategy of using the bond exclusively as a moral hazard mechanism, using the pooling price discussed above, is shown to have merit.

### Economic Impact

Given the results obtained in the lab, there are alternative implementations of the bond that appear to reduce current litigation hazard rates by 53% to 95%, as outlined below.

The current hazard rate is:

[(1−λ)(ρ)+λ(ρ+δ)]*incident rate=(0.67)(0.32)+(0.33)(0.71) =0.45* incident rate

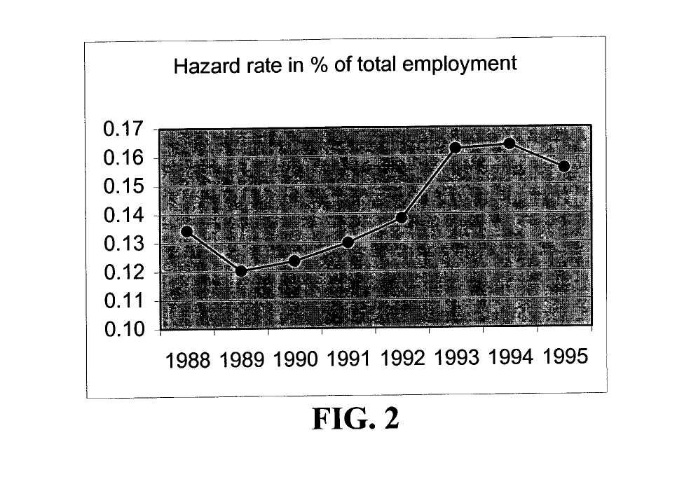

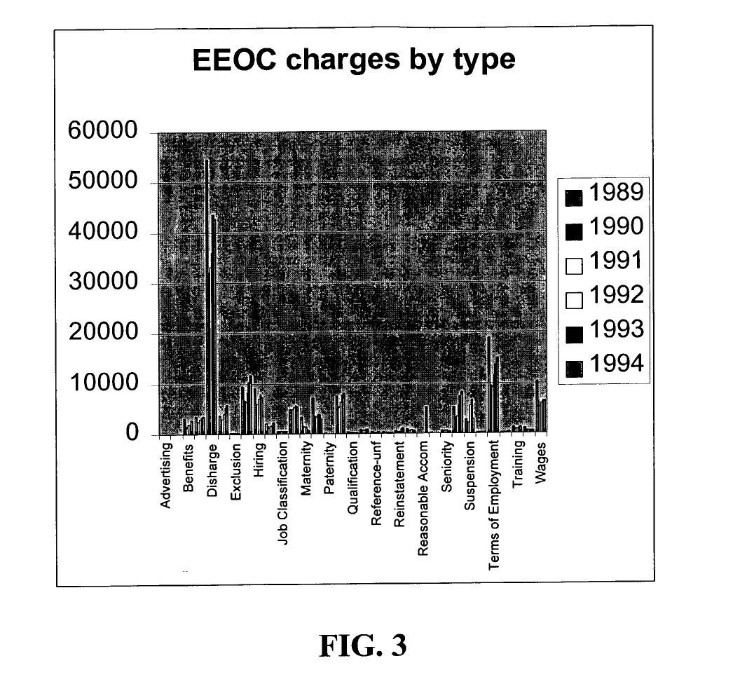

If these figures are applied to the real world hazard rate of 0.160% (from FIG. 2), then the implicit incident rate is 0.36%.

Using the bond as an “adverse selection mechanism” only, removes the litigious employees, and reduces the hazard rate to 0.075%:

(1−λ)(ρ)*incident rate=(0.67)(0.32)(0.0036)=0.075%

Using the bond as a “moral hazard mechanism” only, reduces the suit probabilities from the 0 forfeiture level to the 50,000 forfeiture level, and reduces the hazard rate to 0.053%:

[(1−λ)(ρ)′+λ(ρ+δ)′]*incident rate=[(0.67)(0.03)+(0.33)(0.39)]*(0.0036)=0.053%

Full implementation of the bond (adverse selection mechanism and moral hazard mechanism), removes the litigious employees and reduces the suit probabilities of the non-litigious employees. When both features are activated, the hazard rate drops to 0.007%:

(1−λ)(ρ)′*incident rate=(0.67)(0.03)(0.0036)=0.007%

Accordingly, employers have a number of implementation options, each of which substantially reduces their litigation hazard rate from the current level of 0.16% of employment (number of employees).

In conclusion, the present invention comprises a method of using an anti-discrimination bond to provide a reliable signal of litigation risk to replace the imperfect proxy of protected group membership. Accordingly, the preferred method is intended to jointly solve the employer's problem of minimizing litigation costs, as well as the protected group employee problem of induced discrimination. As demonstrated by experimental evidence, there does appear to be a litigious personality trait. When faced with two equivalent experiments, a litigious individual is more likely to sue an employer, as opposed to pursuing an equivalent lottery. Approximately 33% of the experimental subjects exhibited this litigious personality trait. The operational distinction between the two types of employees is that the two have different litigation thresholds. Non-litigious employees sue their employer with probability 0.32, when confronted with a questionable episode, and when it is costless to do so. In contrast, litigious employees sue with probability 0.71 under the same conditions.

Moreover the litigious personality trait is uncorrelated with a protected group, meaning that an employer's practice of discriminating against protected groups is likely to be ineffective in reducing litigation (in addition to being illegal). The most significant implication however, is that the present method for separating litigious employees (the true risk group) from non-litigious employees does indeed have the potential to reverse induced discrimination

While the presence of the litigious trait is important for the bond mechanism, the ability to evoke this trait in an experiment is also of interest. One of the critical challenges of this experiment was whether the litigation context would be internalized by subjects, given that the differences between the lottery and the lawsuit were based exclusively on verbal description. The fact that it was possible to obtain different results for the lawsuit versus the lottery means we were successful in evoking context. Individuals were not simply treating the experiment as a game. This increased the external validity of the experimental results.

Perhaps the most important conclusion to be drawn is that the bond is an effective mechanism for discriminating between litigious individuals and non-litigious individuals. There was a range of prices over which the probability of bond purchase by non-litigious subjects was 2- to 3-times that of litigious employees. Moreover, because litigiousness is not correlated with protected group membership, it can be used to restore race/gender-blind hiring. This is true because employers can avoid hiring the true risk group (litigious employees), rather than the employees they believe to be at high risk of litigation (the protected groups).

The final conclusion pertains to the effectiveness of the bond as a moral hazard mechanism. The moral hazard feature for non-litigious employees is largely superfluous—their probability of suit is less than 10% for almost any forfeiture amount. However, the bond's moral hazard feature is substantially more important for litigious employees, for whom the inherent probability of suit is quite high, but the probability of suit is sensitive to forfeiture levels.

Maximum benefit from the bond is achieved when it is used jointly as an adverse selection mechanism and a moral hazard mechanism. This occurs when the bond is offered at a separating price (avoiding litigious employees), and when the covered employees have accrued some amount of principal. Since the separating price involves no employer matching, the most effective implementation (hazard rate of 0.007%) is also the least costly.

However, in many situations, full implementation of the bond is not feasible, for example, when the bond is introduced to an existing work force. In those instances, the bond's function shifts towards minimizing moral hazard. In such cases, employers prefer the pooling equilibrium to the separating equilibrium. Since the pooling equilibrium requires employer matching, this implementation is less effective (hazard rate=0.053%), and also the most costly option for the employer. To achieve the pooling equilibrium, it appears that a high level of employer matching is required (50% matching on the highest premium level), to the extent that the cost of matching may exceed the cost of self-insuring (bearing the higher hazard rate). In that case, the bond would not be applicable, and employers would likely continue to discriminate against protected group employees in an effort to reduce their litigation risk.

However, both of these strategies consider only first-order effects from implementing the bond mechanism. There are also two foreseeable second-order effects from real-world implementation. The first pertains to employers, the second to litigious employees, but the effects are related. Once some employers begin offering the anti-discrimination bond to their employees, non-bonding employers become the only recourse for litigious employees. Thus, the hazard rate for non-bonding employers will rise from the current rate of 0. 16% toward 0.25% ((ρ+δ)*incident rate), as these employers capture the discards from the adverse selection process. Since the higher hazard rate substantially increases implicit labor costs relative to bonding rivals, ultimately all employers should be driven toward adopting the method of the present invention.

In addition, eventually litigious employees will find that bonding employers will no longer hire them. At that point, employees would be confronted with two choices: (i) seeking employment from non-bonding employers, or (ii) feigning non-litigiousness with bonding employers. However, the bond mechanism makes it costly to feign non-litigiousness (unlike feigning in a personality instrument). Feigning in this case requires the employee to actually purchase the bond. Accordingly, the moral hazard feature of the bond becomes effective, even though the adverse selection feature may be rendered ineffective.

When viewed in light of a competitive labor market, it appears that all employers will be driven to implement the bond program, and litigious employees will be forced to feign non-litigiousness. At that point, the bond will cease to function as an adverse selection mechanism, and will function exclusively as a moral hazard mechanism. The advantage of a moral hazard equilibrium over the moral hazard strategy discussed above, is employer cost. The moral hazard strategy involved a pooling equilibrium that required employer matching of a sizable premium, whereas by comparison, the eventual moral hazard default of a competitive labor market requires no such matching.

Implementation of the bond as an adverse selection mechanism is costless to employers (other than administrative costs), meaning that the mechanism is effectively costless to the employer. The present strategy ultimately will decrease lawsuit hazards and costs by 95% without imposing new costs on either employers or their non-litigious employees. Thus, the present invention substantially enhances welfare, while leaving penalties intact for employer misconduct intact. This is not true of other remedies that employers are now implementing to reduce their litigation risk, such as Alternative Dispute Resolution (ADR), which currently requires employees to give up their right to sue. In marked contrast, the present bond method preserves an employee's right to sue, while at the same time reducing the incentive to do so.

Accordingly, the bond should lead to a more conciliatory workplace. Although it appears to reward employees for not suing their employer, at a minimum however, it will suppress the view that employees are rewarded for litigious behavior.

Each and every patent, patent application and publication that is cited in the foregoing specification is herein incorporated by reference in its entirety.

While the foregoing specification has been described with regard to certain preferred embodiments, and many details have been set forth for the purpose of illustration, it will be apparent to those skilled in the art that the invention may be subject to various modifications and additional embodiments, and that certain of the details described herein can be varied considerably without departing from the spirit and scope of the invention. Such modifications, equivalent variations and additional embodiments are also intended to fall within the scope of the appended claims.

What is claimed is:

1. A method for reversing induced discrimination by an employer in the workplace, comprising offering an anti-discrimination bond to a prospective employee prior to employment, while retaining penalties for employer misconduct.

2. The method of claim 1, further comprises offering the anti-discrimination bond without introducing net new costs to either employer or employee.

3. The method of claim 1, further comprising using the prospective employee's response to the offering of the anti-discrimination bond as an adverse selection feature to predict that individual's probability of being litigious.

4. The method of claim 3, wherein the adverse selection feature for identifying the litigiousness of an employee is not correlated with that individual's membership in any protected group.

5. The method of claim 4, wherein offering the anti-discrimination bond further comprises discriminating between litigious individuals and non-litigious individuals.

6. The method of claim 4, wherein offering the anti-discrimination bond further comprises reducing law suits.

7. The method of claim 1, wherein offering the anti-discrimination bond further comprises reducing employer litigation costs.

8. The method of claim 5, wherein offering the anti-discrimination bond further comprises reducing an employer's need to discriminate by applying an adverse selection feature for identifying litigious employees ex-ante.

9. The method of claim 5, wherein applying the adverse selection feature is effectively costless to the employer.

10. The method of claim 5, wherein offering the anti-discrimination bond further comprises reducing an employer's need to discriminate by applying a moral hazard feature for inhibiting litigation ex-post.

11. The method of claim 5, wherein offering the anti-discrimination bond further comprises reducing the need to discriminate, by jointly applying at least an adverse selection feature for identifying litigious employees ex-ante, and a moral hazard feature for inhibiting litigation ex-post.

12. The method of claim 4, wherein offering the anti-discrimination bond further comprises restoring race/gender-blind hiring by employers.

13. The method of claim 1, wherein offering the anti-discrimination bond further comprises preserving an employee's right to sue, while at the same time reducing the incentive to do so.

14. The method of claim 1, wherein offering the anti-discrimination bond further comprises creating a more conciliatory workplace.

15. The method of claim 1, wherein offering the anti-discrimination bond further comprises suppressing a view that employees are rewarded for litigious behavior.

16. The method of claim 1, wherein offering the anti-discrimination bond further comprises restoring relative employment opportunities of protected groups to pre-CRA-91 levels.

17. A method for reversing induced discrimination by an employer in the workplace, comprising offering an anti-discrimination bond to an existing employee during the course of employment, while retaining penalties for employer misconduct.

18. The method of claim 17, further comprising using the employee's response to the offering of the anti-discrimination bond as an adverse selection feature to predict that individual's probability of being litigious.

19. The method of claim 18, wherein the adverse selection feature for identifying the litigiousness of an employee is not correlated with that individual's membership in any protected group.

20. The method of claim 19, wherein offering the anti-discrimination bond further comprises discriminating between litigious individuals and non-litigious individuals.
